(19) United States
(12) Patent Application Publication
(10) Pub. No.: US 2026/0142836 A1
(43) Pub. Date: May 21, 2026

(54) METHOD AND SYSTEM FOR UNSTAKING COINS USING BLOCKCHAIN

(71) Applicant: Chan Woo PARK, Busan (KR)

(72) Inventor: Chan Woo PARK, Busan (KR)

(21) Appl. No.: 19/387,114

(22) Filed: Nov. 12, 2025

(30) Foreign Application Priority Data
Nov. 19, 2024 (KR) 10-2024-0165289

(51) Int. Cl. H04L 9/32; H04L 9/00; H04L 9/08

(52) U.S. Cl. CPC H04L 9/3247; H04L 9/0825; H04L 9/50; H04L 2209/56

(57) ABSTRACT

Provided is a method of unstaking coins using blockchain. The method of unstaking coins using blockchain includes receiving, by a server, an unstaking request message for a coin unstaking request from a participant device; performing, by the server, coin unstaking or token minting based on coin unstaking determination information or token minting determination information included in the unstaking request message; generating, by the server, smart contract data for the coin unstaking or token minting and transmitting the smart contract data to at least one blockchain node; and verifying, by the server, the smart contract data through cryptographic verification by the blockchain node, adding a new block including the smart contract to a distributed ledger, and then providing the participant device with a transaction confirmation indicating that the coin unstaking or token minting is immutably recorded on the blockchain.

### CROSS-REFERENCE TO RELATED APPLICATION

This application claims priority to and the benefit of Korean Patent Application No. 2024-0165289, filed on Nov. 19, 2024, the disclosure of which is incorporated herein by reference in its entirety.

### BACKGROUND

### 1. Field of the Invention

The present invention relates to a method and system for unstaking coins using blockchain, and more particularly, to a method and system for unstaking coins that enable participants to perform stable and reliable choices in real time even in situations where a value fluctuates, while maintaining transaction stability and data integrity through a blockchain network during the process of unstaking coins or minting tokens.

### 2. Discussion of Related Art

Coins may be staked on a blockchain network. Staking means that the coins are locked in a state where the coins cannot be traded on the blockchain network for a certain period of time. Since the value of the coins or tokens may fluctuate over time in the blockchain environment, existing technologies, which only support staking and unstaking, make it difficult for users to have options to cope with value fluctuations while maintaining transaction stability and data integrity at the time of unstaking.

### Technical Problem

The technical problem to be solved by the present invention is directed to providing a method and system which allow a user to select between coin unstaking and token minting at the time of coin unstaking, and verify and record transaction data generated during the selection process on the blockchain network to ensure integrity, and realize unstaking processing stability for responding to value fluctuations, which existing technologies fail to provide.

### SUMMARY OF THE INVENTION

According to one aspect of the present invention, a method of unstaking coins using blockchain includes receiving, by a server, an unstaking request message for a coin unstaking request from a participant device, performing, by the server, coin unstaking or token minting based on coin unstaking determination information or token minting determination information included in the unstaking request message, generating, by the server, smart contract data for the coin unstaking or token minting and transmitting the smart contract data to at least one blockchain node, and verifying, by the server, the smart contract data through cryptographic verification by the blockchain node, adding a new block including the smart contract to a distributed ledger, and then providing the participant device with a transaction confirmation indicating that the coin unstaking or token minting is immutably recorded on the blockchain.

Any one selection between the coin unstaking determination information and the token minting determination information may be determined by the participant device.

The method may further include, when the unstaking request message includes the token minting determination information, determining the number of mintable token, and determining the number of tokens to be minted from the number of mintable tokens and including the number of tokens to be minted in the unstaking request message, in which the number of mintable tokens may be calculated based on a ratio of a price of withdrawable coin converted into dollar at the time of coin unstaking to a value of a price per token converted into dollar at the time of coin staking.

According to another aspect of the present invention, a server includes a processor that executes coin unstaking commands using blockchain, and a memory storing the commands, in which the commands are implemented to receive an unstaking request message for a coin unstaking request from a participant device, perform a coin unstaking or token minting based on coin unstaking determination information or token minting determination information included in the unstaking request message, generate smart contract data for the coin unstaking or token minting, transmit the smart contract data to at least one blockchain node, verify the smart contract data through cryptographic verification by the blockchain node, add a new block including the smart contract to a distributed ledger, and then provide the participant device with a transaction confirmation indicating that the coin unstaking or token minting is immutably recorded on the blockchain.

The commands may further include, when the unstaking request message includes the token minting determination information, commands implemented to determine the number of mintable tokens, determine the number of tokens to be minted from the number of mintable tokens, and include the determined number of tokens to be minted in the unstaking request message.

The number of mintable tokens may be calculated based on a ratio of a price of withdrawable coin converted into dollar at the time of coin unstaking to a value of a price per token converted into dollar at the time of coin staking.

### Advantageous Effects

A method and system for unstaking coins using blockchain according to an embodiment of the present invention allow a person who unstakes coins to select either to unstake coins or to mint tokens, thereby enabling the participant to perform a stable and reliable choice in real time even in situations where the value fluctuates at the time of unstaking while maintaining transaction security and data integrity for the person who unstakes the coins. As a result, the present invention goes beyond simple transaction execution by combining verified price data based on an external oracle with smart contracts, thereby enhancing the efficiency and transparency of unstaking processing.

### BRIEF DESCRIPTION OF THE DRAWINGS

In order to more fully understand the drawings cited in the detailed description of the present invention, a detailed description of each drawing is provided.

FIG. 1 illustrates a block diagram of a coin staking/unstaking system using blockchain according to an embodiment of the present invention.

FIG. 2 illustrates a flowchart for describing a coin staking method in the system illustrated in FIG. 1.

FIG. 3 illustrates a flowchart illustrating a coin unstaking method in the system illustrated in FIG. 1

FIGS. 4A and 4B are graphs illustrating price fluctuations of coins and tokens over time.

### DETAILED DESCRIPTION OF EXEMPLARY EMBODIMENTS

Specific structural or functional descriptions disclosed in the present specification will be provided only in order to describe exemplary embodiments of the present invention. Therefore, embodiments of the present invention may be implemented in various forms, and the present invention is not to be interpreted as being limited to exemplary embodiments described in the present specification.

Since exemplary embodiments of the present invention may be variously modified and may have several forms, they will be shown in the accompanying drawings and be described in detail in the present specification. However, it is to be understood that exemplary embodiments of the present invention are not limited to specific forms but includes all modifications, equivalents, and substitutions included in the spirit and the scope of the present invention.

Terms such as “first,” “second,” or the like, may be used to describe various components, but these components are not to be construed as being limited to these terms. The terms are used only to distinguish one component from another component. For example, the “first” component may be named the “second” component and the “second” component may also be similarly named the “first” component, without departing from the scope of the present invention.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element interposed therebetween. Other expressions describing a relationship between components, that is, “between,” “directly between,” “neighboring to,” “directly neighboring to” and the like, should be similarly interpreted.

Terms used in the present specification are used only in order to describe specific exemplary embodiments rather than limiting the present invention. Singular expressions are intended to include plural expressions unless the context clearly represents otherwise. It will be further understood that the terms “comprise” and “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, all the terms used in the present specification, including technical and scientific terms, have the same meanings as meanings that are generally understood by those skilled in the art to which the present invention pertains. Terms generally used and defined in a dictionary are to be interpreted as the same meanings with meanings within the context of the related art and are not to be interpreted as ideal or excessively formal meanings unless clearly indicated in the present specification.

In this specification, staking, saving, or deposit may be used interchangeably. In addition, this specification, cash unstaking, unstaking, or withdrawal may be used interchangeably. In addition, this specification, minting or issuing may be used interchangeably. In addition, in this specification, a participant's operation refers to the use of a command or information using a participant device, and the participant's operation may be understood as the operation of the participant device.

Hereinafter, preferred embodiments of the present invention will be described in detail with reference to the accompanying drawings.

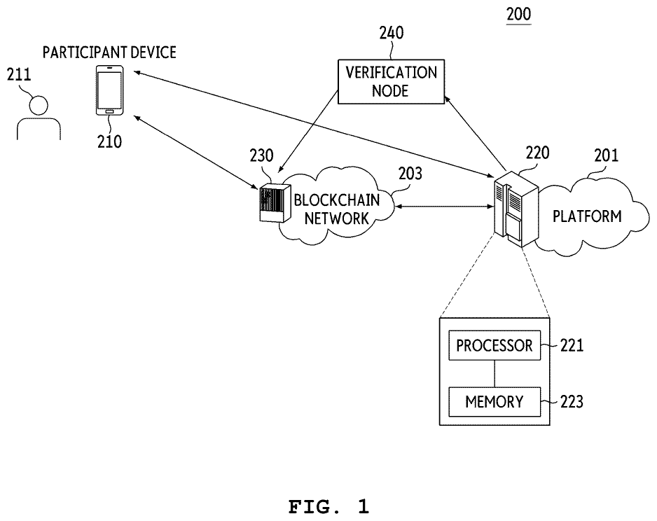

FIG. 1 illustrates a block diagram of a coin staking/unstaking system using blockchain according to an embodiment of the present invention.

Referring to FIG. 1, a system 200 refers to a system that allows a participant 211 to stake or unstake his/her coins within a platform 201 using blockchain. The participant 211 refers to a user participating in the platform 201. The staking refers to that, during the coin staking period, the participant 211 is not allowed to freely handle the staked coins. Through the staking, the participant 211 may expect interest on the coin staking.

The staking refers to the process by which cryptocurrency holders lock up a certain amount of their tokens on a blockchain network to support network operations such as transaction validation and security. In return, participants may earn rewards or additional tokens as an incentive for their contribution. The unstaking is the process of releasing previously staked cryptocurrency tokens, making them available for transfer or use again. It involves unlocking the tokens that were committed for staking, usually after fulfilling certain network-defined conditions or waiting periods.

The unstaking refers to the fact that the participant 211 may again freely handle the staked coins. The handling of coins may refer to selling coins or using coins as payment for purchasing other items.

Within the platform 201, the participant 211 may stake or unstake coins. The coin refers to cryptocurrency with independent blockchains. The coin may be stable coins such as USD coin (USDC) or native coins such as Ethereum (Eth) or Polygon (Pol).

The system 200 includes a participant device 210, a server 220, a blockchain node 230, and a verification node 240.

The participant device 210 refers to an electronic device used by the participant 211 participating in the platform 201. The participant device 210 may be a smartphone, a tablet personal computer (PC), a laptop, or a personal computer (PC).

The participant 211 may stake or unstake coins displayed through a display included in the participant device 210.

The participant 211 may stake coins. The coin may be staked through various means, such as a smart contract applied to the blockchain, the platform 201, or a blockchain wallet. The participant 211 may not freely handle coins staked in the smart contract, the platform 201, the blockchain wallet, etc., during the staking period.

The blockchain is managed by a blockchain network 203. The blockchain network 203 is implemented with a plurality of blockchain nodes. For convenience, only one blockchain node 230 is illustrated in FIG. 1, but it should be understood that the plurality of blockchain nodes exist in reality. The blockchain node 230 may be an electronic device such as a server.

The blockchain is a distributed ledger including a plurality of blocks. Each block includes a block header and one or more data values.

Each block header includes a timestamp, a block reference value, and a data reference value.

The timestamp is the time when the block header is generated.

The block reference value may refer to a block generated earlier. In the block header, the block reference value is a value that refers to the block header of the most recently added block. The block reference value is a hash value. The hash value is generated by hashing the block header of the most recently added block.

The data reference value may refer to one or more data values stored in the block. For example, the data reference value may be a hash value generated by hashing the data values. For example, the data reference value may be a root of a Merkle tree generated using the data values.

The use of the block reference value and the data reference value in each block header makes the blockchain immutable. Any attempt to change a data value requires the generation of a new data reference value for the block. The generation of the new data reference value requires the generation of new block reference values for each subsequent block. The newly generated block reference values should be updated across all blockchain nodes 230.

The blockchain may be used to store information related to a blockchain transaction performed between two different blockchain wallets. For example, the blockchain transaction may be performed in which coins are transferred from the blockchain wallet of the participant 211 to another blockchain wallet based on a coin staking. In some embodiments, even when coins are staked, the coins may not be moved from the blockchain wallet of the participant 211. However, the participant 211 may not freely trade the staked coins. Once coins are staked, the coins equivalent to the number of coins staked are locked during the staking period. Therefore, the participant 211 may not freely trade the coins. When the staked coins are unstaked, the blockchain transaction may be performed in which coins moved to another blockchain wallet are transferred back to the same blockchain wallet. In some embodiments, even when coins are unstaked, the coins may not be moved from the blockchain wallet of the participant 211. When coins are unstaked, the participant 211 may freely trade the coins again.

The blockchain wallet may include a private key. The private key is used to generate a digital signature used for authentication in blockchain transactions. The digital signature may be verified by the blockchain network 203 using a public key. The public key may be generated using the private key.

The blockchain wallet may refer to a private key. According to an embodiment, the blockchain wallet may refer to an electronic device (e.g., a participant device 210) that stores a private key used for blockchain transactions. The participant device 210 includes a private key. The blockchain transaction may refer to a staking or unstaking of coins.

Each blockchain data value stored on the blockchain corresponds to a blockchain transaction. The blockchain transaction includes a digital signature of the participant device 210 and a blockchain currency amount. The digital signature of the participant 211 is generated using the private key of the participant device 210.

In the blockchain transaction, the transaction may include a blockchain address of the participant device 210. Additionally, the transaction may include the public key of the participant device 210. The public key of the participant device 210 is used to determine the validity of the transaction. The blockchain node 230 may verify the digital signature using the public key of the participant device 210. The blockchain node 230 verifies the confirmation of the transaction and includes a blockchain transaction in a new block. The new block may be verified by other blockchain nodes in the blockchain network 203 and then distributed to other blockchain nodes in the blockchain network 203.

Records of coin staking or unstaking may be stored in blockchain data values in blockchain blocks associated with the blockchain network 203. Data values representing the coin staking or unstaking are stored in the blockchain data values. The coin staking or unstaking is recorded on the blockchain by adding a new blockchain data value to a new block. The new blockchain data value includes the number of coins being staked or unstaked, i.e., the blockchain currency amount.

The server 220 includes a processor 221 that executes coin unstaking commands using the blockchain and a memory 223 that stores the commands.

The server 220 receives data from the participant device 210, the blockchain node 230, or the verification node 240. The data may refer to a request message, a transaction identifier, a token identifier, or smart contract data.

The server 220 includes blockchain data including a plurality of blocks. The blockchain data may be blockchain-related data, such as a block generation algorithm, a digital signature generation and verification algorithm, communication data for the blockchain node 230, the smart contract, the private key, and the public key.

The server 220 generates the blockchain transaction, the blockchain data, the digital signature, the block, etc.

The verification node 240 may perform a verification operation. The verification operation may include an operation of verifying the digital signature using the signature generation algorithm, an operation of verifying the hash values, an operation of verifying the coin staking or unstaking based on the blockchain addresses, or an operation of verifying payment transactions. The verification node 240 may be a smartphone, a tablet PC, a laptop, or a personal computer.

In FIG. 1, the verification node 240 is illustrated as being separate from the blockchain network 203. However, according to the embodiment, the verification node 240 may be any one of the plurality of blockchain nodes included in the blockchain network 203.

According to an embodiment, the server 220 may also perform the verification operation.

The server 220 may implement the platform 201 for staking or unstaking coins from the participant device 210. The platform 201 may be implemented with commands for a graphics user interface (GUI), transaction processing operations, etc., required for the coin staking or unstaking.

The participant device 210 may convert coins into tokens through the platform 201.

In addition, the participant device 210 may convert tokens into coins through the platform 201. In this case, the tokens are deleted.

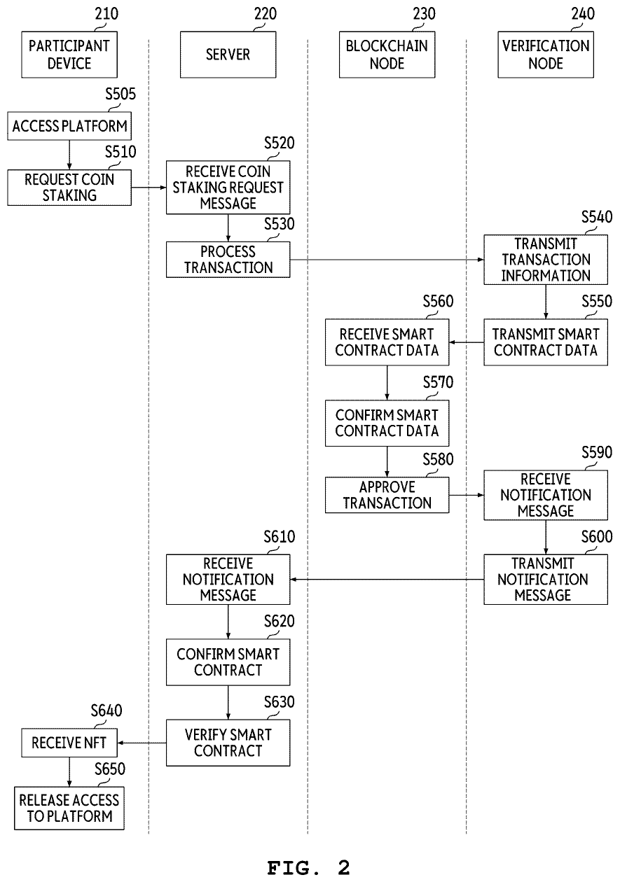

FIG. 2 illustrates a flowchart for describing the coin staking method in the system illustrated in FIG. 1.

Referring to FIGS. 1 and 2, the participant device 210 is connected to a blockchain wallet (e.g., MetaMask) to access the platform 201. When the participant device 210 attempts to access the platform 201 (e.g., by pressing the connection button), the server 220 transmits an access request signal to the participant device 210. When the server 220 transmits the access request signal to the participant device 210, a message requesting access approval is displayed on the participant device 210. The participant device 210 accesses the platform 201 (S505).

When the message is displayed on the participant device 210, the participant device 210 may sign authorization using the private key. The signature refers to the digital signature. The signature allows the platform 201 to view the wallet address.

The participant device 210 transmits a coin staking request message requesting a coin staking (S510). The “staking” refers to a saving or a deposit.

The server 220 receives the coin staking request message (S520).

The coin staking request message includes the blockchain address of the participant device 210, a transaction identifier, a coin type, or the number of coins to be staked. The transaction identifier refers to transaction identification (ID).

The server 220 processes the staking transaction (S530). The server 220 verifies the transaction identifier for the staking transaction. According to an embodiment, the server 220 may generate the transaction identifier. The server 220 stakes the number of coins to be staked and a token price at the time of staking into the smart contract, the platform 201, or the blockchain wallet.

The token refers to a digital asset that operates on the existing blockchain instead of an independent blockchain. The token is different from a non-fungible token (NFT). That is, minting a token is different from minting an NFT. The token may refer to a cryptocurrency that performs traditional financial functions, such as lending, savings, insurance, or trading, that operates on the existing blockchain instead of an independent blockchain. The token may be a decentralized finance (DeFi) token. The token may be minted within the platform 201.

The server 220 transmits transaction information to the verification node 240 (S540). The transaction information includes the transaction identifier, the blockchain address of the participant device 210, the coin type, the number of coins to be staked, or the token price at the time of staking. That is, the server generates smart contract data and transmits the generated smart contract data to the blockchain node 240. The blockchain node 240 may be the verification node 240.

Minting refers to the creation of new tokens on a blockchain network. This process involves generating new cryptocurrency units, either as rewards for staking or through predefined smart contract rules, thereby increasing the total supply of the token. “Minting” and “issuing” may be used interchangeably.

In addition, the server 220 may generate the smart contract data using the coin unstaking determination information or token minting determination information included in the unstaking request message from the participant 211. The smart contract data includes participant's selection details and is recorded on the blockchain node 230. The smart contract data may then be finally reflected in the blockchain ledger through consensus algorithms (e.g., proof of work (PoW), proof of stake (PoS), practical Byzantine fault tolerance (PBFT), etc.) of the blockchain nodes. Since this allows the selection details related to the unstaking processing to be immutably stored in the blockchain ledger, the selection details can be verified in the event of a dispute or error in the future. The blockchain ledger refers to a distributed ledger.

The verification node 240 transmits the smart contract data to the blockchain node 230 (S550). The smart contract data refers to data related to the smart contract. Although referred to as the blockchain node 230, the block chain node 230 may be understood as the plurality of blockchain nodes. In other words, the verification mode 240 broadcasts the smart contract data to the plurality of blockchain nodes.

The smart contract data includes the transaction identifier for the processed staking transaction, the blockchain address of the participant device 210, the coin type, the number of coins to be staked, or the token price at the time of staking.

The blockchain node 230 receives the smart contract data (S560).

The blockchain node 230 validates the smart contract data for the staking transaction (S570).

The blockchain node 230 uses the smart contract data to generate the smart contract and generates a new block including the smart contract. The blockchain node 230 adds the generated new block to the blockchain. The new block may not be changed. The blockchain node 230 verifies the smart contract through cryptographic verification and operates as part of the consensus process by deriving the same result as other blockchain nodes in accordance with a consensus algorithm, and after the consensus is completed, adds a new block including the smart contract data to the distributed ledger. The cryptographic verification described above refers to the operation of verifying the digital signature or hash values.

The smart contract is a program stored in the blockchain node 230 when predetermined conditions are satisfied and is used to automatically execute an event or action according to the terms of the contract. The event or action may refer to a staking transaction or a unstaking transaction. The staking transaction is completed.

The blockchain node 230 transmits a notification message to the verification node 240 indicating that the smart contract has been successfully added to the blockchain (S580). Transmitting the notification message may refer to transaction approval.

The verification node 240 receives the notification message from the blockchain node 230 (S590).

The notification message includes the transaction identifier for the processed staking transaction, the blockchain address of the participant device 210, the coin type, the number of coins to be staked, or the token price at the time of staking. The verification node 240 may receive the notification message via the network.

The verification node 240 transmits the notification message to the server 220 (S600).

The server 220 receives the notification message from the verification node 240 (S610).

The server 220 identifies the smart contract stored in the blockchain using the transaction identifier (S620).

The server 220 verifies the accuracy of the transaction identifier by verifying whether the transaction identifier stored in the server 220 matches the transaction identifier included in the notification message (S630). By verifying the accuracy of the transaction identifier, the server 220 may verify the smart contract.

The participant device 210 receives the NFT as a staking certificate from the server 220 (S640).

The participant device 210 deletes the signature to release access to the platform 201 (S650).

The server 220 provides the participant device 210 with a transaction confirmation indicating that the coin unstaking or token minting has been immutably recorded on the blockchain.

According to another embodiment of the present invention, the server 220 may automatically calculate an option (coin unstaking or token minting) with high transaction processing efficiency at the current point in time based on price data collected through oracles and network conditions, and propose the calculated option to the participant 211. The participant 211 may accept or reject the proposal of the server 220. When accepted the proposal, the proposal may be reflected in the smart contract data and recorded on the blockchain node 230.

In the present invention, the “transaction confirmation” refers to the notification message generated after the blockchain node verifies the unstaking transaction or token minting transaction and successfully adds the corresponding smart contract to the blockchain. The notification message may include information on the transaction identifier, the blockchain address of the participant device, the coin type, the unstaking or minting amount, and a transaction recording time. The notification message is transmitted from the blockchain node to the server via the verification node, and the server 220 provides the notification message to the participant device, allowing the participant device to confirm that the transaction has been immutably recorded on the blockchain. Therefore, the transaction confirmation is a technical data transmission process that ensures that the transaction has been successfully verified and recorded on the blockchain network.

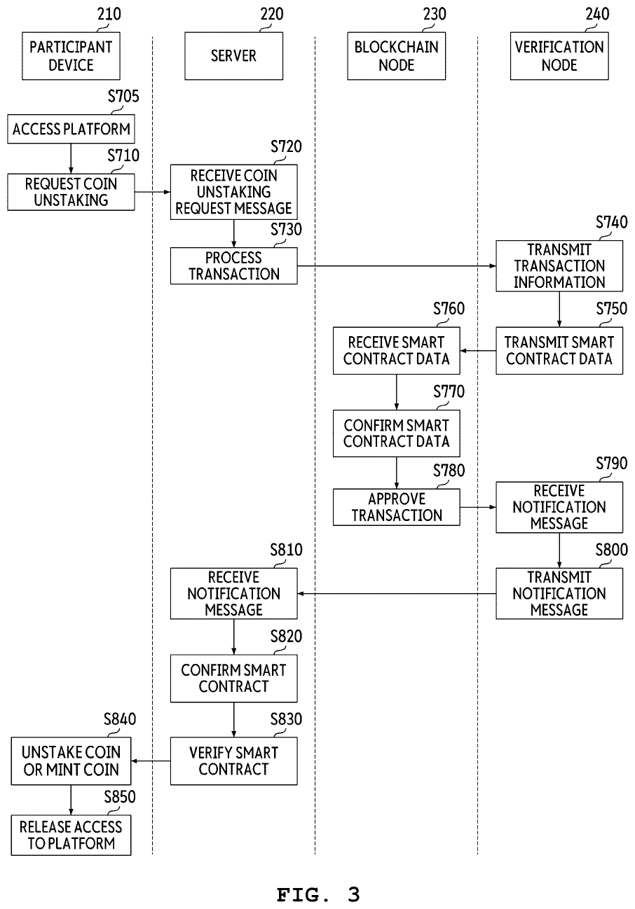

FIG. 3 illustrates a flowchart illustrating a coin unstaking method in the system illustrated in FIG. 1.

Referring to FIGS. 1 and 3, the participant device 210 accesses the platform 201 (S705).

The participant device 210 transmits a unstaking request message requesting the unstaking of staked coins to the server 220 (S710). The unstaking means that the participant 211 may freely handle coins again.

The server 220 receives the unstaking request message from the participant device 210 regarding the coin unstaking request (S720). The unstaking request message includes either the coin unstaking determination information or the token minting determination information. In addition, the unstaking request message may further include the blockchain address of the participant device 210, the transaction identifier, and the coin type.

The coin unstaking determination information indicates that the staked coins will be unstaked as coins. The coin unstaking determination information includes the number of coins to be unstaked.

The token minting determination information indicates that the staked coins will be minted as tokens. The tokens are digital assets that operate on the existing blockchain instead of the independent blockchain and are different from the NFT. For example, the token may be a Rebuy token operating on the platform 201. The token minting determination information includes the type and amount of tokens to be minted.

The GUI that may select either the coin unstaking determination information or the token minting determination information for the coin unstaking is displayed on the display of the participant device 210.

The selection of either the coin unstaking determination information or the token minting determination information is determined by the participant 211. In other words, the determination is made by the participant 211 using the participant device 210.

The participant 211 may choose, between the coin unstaking determination information and the token minting determination information, the one that provides greater transaction processing efficiency for the participant through rapid verification and recording of transaction data on the blockchain network and optimization of computational resources. The “transaction processing efficiency” refers to reducing delays and resource consumption that occur during the verification and recording of transaction data when performing the coin unstaking or token minting on the blockchain network, and providing transaction results quickly and reliably, thereby enabling the participant to make a more rational and advantageous choice under the same conditions.

On the other hand, when the participant 211 determines that minting tokens is more efficient in terms of the transaction processing for the participant 211, the participant device 210 may select the token minting determination information. When the participant 211 determines that the number of tokens that the participant 211 may mint provides more efficient in terms of the transaction processing than the number of coins that the participant 211 may unstake for the coin unstaking, the participant device 210 may select the number of tokens that the participant 211 may mint.

The number of tokens that the participant 211 may mint when the coins are unstaked is calculated by dividing the USD-converted price of the coins withdrawable at the time of unstaking by the USD-converted unit price of the tokens at the time of coin staking.

According to an embodiment of the present invention, the coin and token price data is automatically collected and verified through external blockchain data oracles. The oracles obtain price information from external exchanges, financial data providers, or other trusted data sources. The corresponding data is verified by the smart contract on the blockchain network and then provided to the server 220. This ensures the reliability and integrity of the price data, preventing forgery, alteration, or errors during the calculation process.

The unstaking time of coins refers to the time when the participant 211 requests the coin unstaking using the participant device 210 (S710), and the staking time of coins refers to the time when the coin staking is requested (S510). This may be summarized in Equation 1 below.

$$Number of minable tokens upon unstaking request = ( USD - converted price of coins withdrawable at the time of coin unstaking ) / ( USD - converted unit price of tokens at the time of coin staking ) \qquad Equation 1$$

When the USD-converted unit price of tokens at the time of coin unstaking increases compared to the USD-converted unit price of tokens at the time of coin staking, the participant 211 determines that minting tokens is more efficient in the processing transactions than unstaking coins. Therefore, the participant 211 will select the token minting determination information to mint tokens when coins are unstaked.

On the other hand, when the USD-converted unit price of tokens at the time of coin unstaking decreases compared to the USD-converted unit price of tokens at the time of coin staking, the participant 211 determines that minting tokens is more efficient in the processing transactions than unstaking coins. Therefore, the participant 211 will select the token minting determination information to mint tokens when coins are unstaked.

For example, it is assumed that the participant 211 stakes 1,000 USDC coins. The USDC is a type of coin and represents the unit of the coin.

TABLE 1

| | Coin staking | | | | | |
|---|---|---|---|---|---|---|
| | Number | USDC (Stable Coin) | | Rebuy | | |
| | of | Price | USD- | Price | Number | % |
| | staked | per 1 | converted | per 1 | of | converted |
| Division | coins | USDC | price | Rebuy | tokens | price |
| Staking | 1,000 | $1 | $1,000 | $2 | — | — |
| time | USDC | | | | | |

The Rebuy is a type of token.

It is assumed that the participant 211 unstakes the staked coin after one year.

TABLE 2

| | Coin unstaking (after 1 year) | | | | | | |
|---|---|---|---|---|---|---|---|
| | | USDC (Native Coin) | | Rebuy | | | |
| | Number of | Price | USD- | Price | Number of | | |
| | withdrawable | per 1 | converted | per 1 | mintable | Minting | Participant |
| Division | coins | USDC | price | Rebuy | tokens | value | selection |
| Case 1 | 1,000 USDC | $1 | $1,000 | $1 per | 500 | $500 | Coin |
| | | | | unit | | | unstaking |
| Case 2 | 1,000 USDC | $1 | $1,000 | $4 per | 500 | $2,000 | Coin |
| | | | | unit | | | Minting |

For example, in Table 2, the USDC conversion value at the time of coin unstaking is $1,000, and the price per token at the time of staking is $2. Therefore, the number of mintable tokens at the time of unstaking request is calculated as $1,000÷$2=500. In this case, since all price data used is collected and verified based on the oracles, participants may reliably select the coin unstaking or token minting based on the verified external data.

Therefore, the present invention goes beyond merely allowing selections based on price fluctuations and has the effect of providing an efficient and reliable unstaking environment by automatically collecting and verifying the oracles-based price data, thereby maintaining transaction stability and data integrity even in the situations where the value fluctuations occur at the time of unstaking.

The basis for calculating the number of mintable tokens at the time of unstaking request, that is, the number of Rebuy tokens mintable, is as follows.

In Case 1, after one year, that is, at the time of coin unstaking, the USD-converted price of coin converted into USD is $1,000, and the price per token converted into USD at the time of coin staking is $2, so the number of mintable tokens at the time of unstaking request i.e., the number of mintable Rebuy tokens is $1,000/$2=500.

In Case 2, after one year, that is, at the time of coin unstaking, the USD-converted price of coin converted into USD is $1,000, and the price per token converted into USD at the time of coin staking is $2, so the number of mintable tokens at the time of unstaking request i.e., the number of mintable Rebuy tokens is $1,000/$2=500.

In Case 1, since the price per Rebuy token converted into USD decreases at the time of coin unstaking compared to the time of the coin staking, it is advantageous for the participant 211 to unstake USDC coins. Therefore, in Case 1, the participant device 210 chooses to unstake USDC coins. The unstaking request message includes the number of USDC coins that the participant 211 may unstake. The participant device 210 may unstake the desired number of coins. The number of coins that the participant 211 may unstake is 1,000. In this case, it is assumed that each USDC is $1.

In Case 2, since the price per Rebuy token converted into USD increases at the time of unstaking compared to the staking time, it is advantageous for the participant 211 to mint Rebuy tokens. Therefore, in Case 2, the participant device 210 chooses to mint the Rebuy tokens. The unstaking request message includes the number of Rebuy tokens that the participant 211 may mint. In this case, the number of tokens that may be minted is 500.

When the participant device 210 selects the coin unstaking determination information, the participant device 210 may receive coins. In this case, the participant device 210 may determine the number of coins to be received. The number of coins is included in the unstaking request message.

When the participant device 210 selects the token minting determination information, the participant device 210 may mint tokens instead of receiving coins. In this case, the participant device 210 may determine the number of tokens to be minted. The number of tokens is included in the unstaking request message.

The server 220 receives the unstaking request message (S720).

The server 220 processes the coin unstaking request using the unstaking request message (S730). The server 220 verifies the transaction identifier for the unstaking transaction. According to an embodiment, the server 220 may generate the transaction identifier.

At the request of the participant device 210, the server 220 may freely process the number of coins requested for unstaking by the participant 211 or may permit the participant device 210 to mint tokens in a number equivalent to the value of the tokens corresponding to the number of coins requested for unstaking. The server 220 may unstake coins or mint tokens based on the coin unstaking determination information or the token minting determination information included in the unstaking request message.

The server 220 transmits the transaction information to the verification node 240 (S740). The transaction information includes the transaction identifier, the blockchain address of the participant device 210, the coin type, and the token price at the time of unstaking. The transaction information includes the number of coins to be unstaked or the number of tokens to be minted.

The verification node 240 transmits the smart contract data to the blockchain node 230 (S750). The smart contract data refers to the data related to the smart contract. The smart contract data includes the transaction identifier for the processed unstaking transaction, the blockchain address of the participant device 210, the coin type, and the token price at the time of unstaking. The smart contract data also includes the number of coins to be unstaked or the number of tokens to be minted.

The blockchain node 230 receives the smart contract data (S760).

The blockchain node 230 validates the smart contract data for the unstaking transaction (S770).

The blockchain node 230 uses the smart contract data to generate the smart contract and generates a new block including the smart contract. The blockchain node 230 adds the generated new block to the blockchain. The new block may not be changed. The unstaking transaction is completed.

The blockchain node 230 transmits a notification message to the verification node 240 indicating that the smart contract has been successfully added to the blockchain (S780). Transmitting the notification message may refer to transaction approval.

The verification node 240 receives the notification message from the blockchain node 230 (S790).

The notification message includes the transaction identifier for the processed unstaking transaction, the blockchain address of the participant device 210, the coin type, and the token price at the time of unstaking. The notification message also includes the number of coins to be withdrawn or the number of tokens to be minted. The verification node 240 may receive the notification message via the network.

The verification node 240 transmits the notification message to the server 220 (S800).

The server 220 receives the notification message from the verification node 240 (S810).

The server 220 identifies the smart contract stored in the blockchain using the transaction identifier (S820).

The server 220 verifies the accuracy of the transaction identifier by verifying whether the transaction identifier stored in the server 220 matches the transaction identifier included in the notification message (S830). By verifying the accuracy of the transaction identifier, the server 220 may verify the smart contract.

The participant device 210 may freely process the number of coins requested for unstaking by the participant 211, or mint tokens equivalent to the value of the tokens corresponding to the number of coins requested for unstaking (S840).

The participant device 210 deletes the signature to release access to the platform 201 (S850).

According to the present invention, when the participant 211 stakes or unstakes coins on the platform 201, the transaction is automatically verified and recorded via the smart contract on the blockchain network, thereby enabling stable unstaking processing without additional risk. Therefore, the platform 201 may provide the participant 211 with a reliable trading environment where the transaction stability and data integrity is guaranteed.

Furthermore, the present invention allows the participant 211 to choose between the coin unstaking and the token minting by considering the highly volatile nature of tokens, thereby ensuring the stable and reliable transaction processing even in the situations where the value fluctuates at the time of unstaking. As a result, it is possible to improve the transaction processing efficiency and system reliability.

The smart contract data may include the recommendation relationship of the participant 211.

The participant 211 may have a fee discount based on the recommendation relationship. For example, when the participant 211 signs up using a recommendation code of another participant, the smart contract data includes a recommendation relationship with another participant, and the participant 211 may have a discount at a certain rate when paying the unstaking fee.

The other participant or the administrator may receive a commission based on the recommendation relationship of the participant 211. For example, when the participant 211 signs up using the recommendation code of another participant, the smart contract data includes the recommendation relationship with another participant, and the unstaking fee of the participant 211 may be partially paid to another participant as a commission. For example, when the participant 211 designates an administrator, the smart contract data includes the recommendation relationship with the administrator, and the unstaking fee of the participant 211 may be partially paid to the administrator as a commission.

The smart contract data may include a tier based on the number of tokens held by the participant 211.

The participant 211 may have a fee discount based on his/her tier. For example, when the number of tokens held by the participant 211 is ranked within the top 10% of all users, the participant 211 is considered Gold tier and may have a 20% discount when paying the unstaking fee. For example, when the number of tokens held by the participant 211 is ranked between the top 10% and the top 20% of all users, the participant 211 is considered Silver tier and may have a 10% discount when paying the unstaking fee.

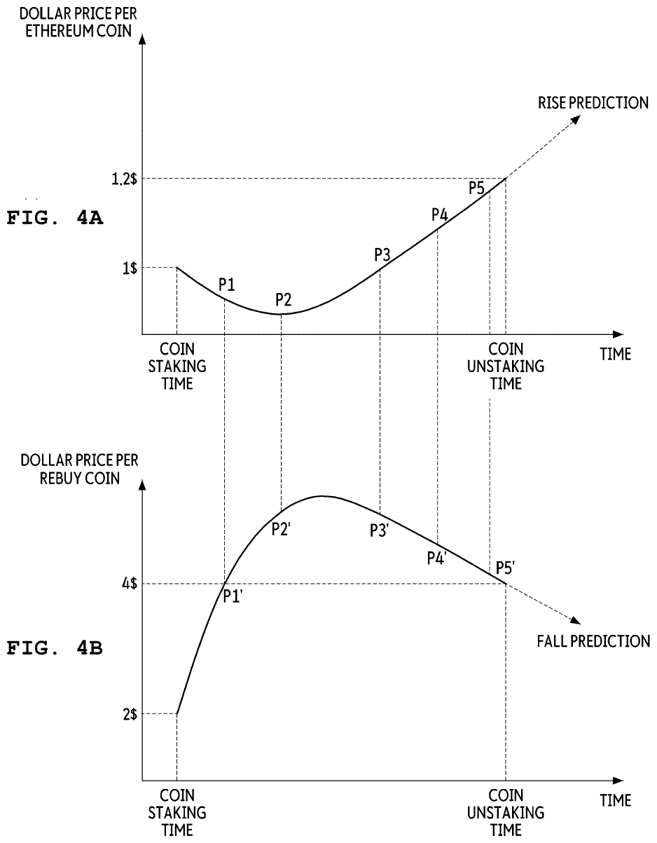

FIGS. 4A and 4B are graphs illustrating price fluctuations of coins and tokens over time.

Referring to FIGS. 1 to 4B, when the server 220 receives the unstaking request message (S720), the server 220 may transmit a proposal message to the participant 211 that suggests a more efficient transaction processing option. Here, the participant 211 refers to the participant device 210.

The participant 211 may unstake various types of coins.

USDC coins are coins whose dollar price per coin remains constant over time. However, Eth coins are coins whose dollar price per coin may fluctuate over time. Hereinafter, the Eth coins will be referred to as Ethereum coins. Therefore, in FIGS. 4A and 4B, the Eth coins will be used as an example instead of the USDC coins.

To transmit the proposal message to the participant device 210, the server 220 compares the past dollar price trend per coin with the dollar price trend per token.

Specifically, the server 220 calculates a rate of change (e.g., −40%) in the dollar price per coin at specific points (e.g., P1 and P2) in the past. For example, the rate of change (e.g., −40%) in the dollar price per coin may be expressed by the following Equation.

$$- 40 \% = ( \$0 \text{.3} - \$0 \text{.7} ) / ( 2 - 1 ) * 100 \% \qquad Equation 2$$

The −40% represents the rate of change in the dollar price per coin, the $0.3 represents the dollar price per coin at a second specific point in time P2 in the past, the $0.7 represents the dollar price per coin at a first specific point in time P1 in the past, and the 2 and 1 represent the second specific point in time P2 in the past and the first specific point in time P1 in the past, respectively.

The specific points in time in the past may be arbitrarily selected, and the number of specific points in time in the past may also be arbitrarily selected.

Similarly, the server 220 calculates the rates of change (e.g., 40%, 30%, and 30%) in the dollar price per coin at specific points in time (e.g., P2 and P3, P3 and P4, and P4 and P5).

The server 220 calculates the rate of change (e.g., 300%) of the dollar price per token at specific points in time (e.g., P1 and P2) in the past. The rate of change (e.g., 300%) of the dollar price per token may be expressed by the following Equation.

$$300 \% = ( \$7 - \$4 ) * ( 2 - 1 ) * 100 \% \qquad Equation 3$$

The 300% represents the rate of change in the dollar price per token, the $7 represents the dollar price per token at a second specific point in time P2 in the past, the $4 represents the dollar price per token at a first specific point in time P1 in the past, and the 2 and 1 represent the second specific point in time P2 in the past and the first specific point in time P1 in the past, respectively.

Similarly, the server 220 calculates the rates of change (e.g., −5%, −30%, and −30%) in the dollar price per token at specific points in time (e.g., P2 and P3, P3 and P4, and P4 and P5).

The server 220 compares the rates of change (e.g., −40%, 40%, 30%, and 30%) in the dollar price per coin at specific points in time (e.g., P1 and P2, P2 and P3, P3 and P4, and P4 and P5) in the past with the rates of changes (e.g., 300%, −5%, −30%, and −30%) in the dollar price per token at specific points in time (e.g., P1 and P2, P2 and P3, P3 and P4, and P4 and P5) in the past. Specifically, the server 220 determines whether the difference between each of the rates of change (e.g., −40%, 40%, 30%, and 30%) in the dollar price per coin at specific points in time (e.g., P1 and P2, P2 and P3, P3 and P4, and P4 and P5) in the past and each of the rates of change (e.g., 300%, −5%, −30%, and −30%) in the dollar price per token at specific points in time (e.g., P1 and P2, P2 and P3, P3 and P4, and P4 and P5) in the past is less than an arbitrary value.

When it is determined that the differences between the rates of change (e.g., −40%, 40%, 30%, and 30%) in the dollar price per coin at specific points in time (e.g., P1 and P2, P2 and P3, P3 and P4, and P4 and P5) in the past and the rates of change (e.g., 300%, −5%, −30%, and −30%) in the dollar price per token at specific points (e.g., P1 and P2, P2 and P3, P3 and P4, and P4 and P5) in the past are all less than an arbitrary value, the server 220 determines that the dollar price trend per coin in the past and the dollar price trend per token are similar.

When any one of the differences between the rates of changes (e.g., −40%, 40%, 30%, and 30%) in the dollar price per coin at specific points in time (e.g., P1 and P2, P2 and P3, P3 and P4, and P4 and P5) in the past and the rates of change (e.g., 300%, −5%, −30%, and −30%) in the dollar price per token at specific points in time (e.g., P1 and P2, P2 and P3, P3 and P4, and P4 and P5) in the past is greater than any value, the server 220 determines that the dollar price trend per coin in the past and the dollar price trend per token are not similar. For example, since the differences between the rates of change (e.g., −40%, 40%, 30%, and 30%) in the dollar price per coin at specific points in time (e.g., P1 and P2, P2 and P3, P3 and P4, and P4 and P5) in the past and the rates of change (e.g., 300%, −5%, −30%, and −30%) in the dollar price per token at specific points in time (e.g., P1 and P2, P2 and P3, P3 and P4, and P4 and P5) (340 (=300%+40%), −450 (=−5%−40%), −60=(−30%−30%), and −60=(−30%−30%)) in the past are all greater than any value (e.g., 20), the server 220 determines that the dollar price trend per coin in the past and the dollar price trend per token are not similar. The differences represent absolute values. For example, a difference of −60 is set to 60, which is compared to an arbitrary value (e.g., 20). The arbitrary value may be set arbitrarily.

When the past dollar price trend per coin and the dollar price trend per token are determined to be similar, the server 220 does not transmit the proposal message to the participant device 210 that suggests a more efficient transaction processing option to the participant 211.

When the past dollar price trend per coin and the dollar price trend per token are determined to be dissimilar, the server 220 predicts a rise or fall in the dollar price per coin or the dollar price per token based on the coin unstaking time. By determining whether the past dollar price trend per coin and the past dollar price trend per token are similar to each other before predicting a rise or fall in the dollar price per coin or token, the computations required to predict a rise or fall in the dollar price per coin or token may be omitted, thereby reducing the burden on the processor 221.

In Case 2 of Table 2 above, the participant device 210 chooses to mint the Rebuy token. That is, when the server 220 receives the unstaking request message including the number of tokens that the participant 211 may mint for the deposit withdrawal, the server 220 determines whether the fall in the dollar price per token is predicted and the rise in the dollar price per coin is predicted.

The server 220 may predict the dollar price per token and the predicted dollar price per token by taking into account the past price history between the coin staking time when the participant device 210 stakes coins, and the coin unstakes time when the participant device 210 withdraws coins.

The past price history refers to the past price history between the coin staking time when the participant device 210 stakes coins, and the coin unstakes time when the participant device 210 withdraws coins again.

For example, the server 220 may generate a graph using the price information in the past price history and predict the price based on the generated graph. When the slope of the graph generated based on the coin unstaking time is positive, the server 220 predicts the rise in price. Referring to FIG. 4A, since the slope of the graph generated based on the coin unstaking time is positive, the server 220 may predict that the dollar price per Eth coin will rise. When the slope of the graph generated based on the coin unstaking point is negative, the server 220 predicts the fall in price. Referring to FIG. 5B, since the slope of the graph generated based on the coin unstaking point is negative, the server 220 may predict the fall in the dollar price per Rebuy token.

When the server 220 determines that the dollar price per coin is expected to rise and the dollar price per token is expected to fall, the server 220 may transmit a proposal message to the participant device 210 suggesting either receiving all of the Eth coins instead of minting Rebuy tokens in response to the coin unstaking request, or receiving a portion in Eth coins and minting the remainder as Rebuy tokens. The ratio of these portions may be arbitrarily determined by the participant device 210. For example, when the number of mintable tokens is 720, instead of minting all 720 Rebuy tokens, some of the 720 Rebuy tokens may be minted as 360 Rebuy tokens, and the remainder may be received as Eth coins corresponding to the USD conversion value. 360 Rebuy tokens are $1,440, and the USD-converted price according to the coin unstaking request is $2,880, after $1,440 corresponding to 360 Rebuy tokens is deducted from $2,880, the remaining amount is $1,440. Since the price of one Eth coin is $1.2, the participant device 210 may mint 360 Rebuy tokens and receive 1,200 Eth coins ($1,440/$1.2).

After receiving the above-described proposal message from the server 220, the participant device 210 may retransmit, to the server 220, the unstaking request message that determines whether to receive all Eth coins, or to receive some Eth coins and mint some Rebuy tokens, instead of minting the Rebuy tokens for the coin unstaking request.

According to another embodiment of the present invention, the server 220 may calculate expected results for each case of the coin unstaking or token minting prior to the selection of the participant 211 and provide the expected results to the participant 211. For example, the server 220 may calculate and display the number of withdrawable coins and the number of mintable tokens in real time based on price data and network status verified through the oracles. As a result, the participant 211 may confirm the results in advance before making a selection to make the stable and reliable unstaking determination.

Although the present invention has been described with reference to exemplary embodiments shown in the accompanying drawings, it is only an example. It will be understood by those skilled in the art that various modifications and equivalent other exemplary embodiments are possible from the present invention. Accordingly, an actual technical protection scope of the present invention is to be defined by the following claims.

1. A method of unstaking coins using blockchain, comprising:
receiving, by a server, an unstaking request message for a coin unstaking request from a participant device;
performing, by the server, coin unstaking or token minting based on coin unstaking determination information or token minting determination information included in the unstaking request message;
generating, by the server, smart contract data for the coin unstaking or token minting and transmitting the smart contract data to at least one blockchain node; and
verifying, by the server, the smart contract data through cryptographic verification by the blockchain node, adding a new block including the smart contract to a distributed ledger, and then providing the participant device with a transaction confirmation indicating that the coin unstaking or token minting is immutably recorded on the blockchain.

2. The method of claim 1, wherein any one selection between the coin unstaking determination information and the token minting determination information is determined by the participant device.

3. The method of claim 2, further comprising:
when the unstaking request message includes the token minting determination information, determining a number of mintable tokens; and
determining a number of tokens to be minted among the number of mintable tokens and including the number of tokens to be minted in the unstaking request message,
wherein the number of mintable tokens is calculated based on a ratio of a price of withdrawable coin converted into dollar at the time of coin unstaking to a value of a price per token converted into dollar at the time of coin staking.

4. A server comprising:
a processor that executes coin unstaking commands using blockchain; and
a memory storing the commands,
wherein the commands are implemented to receive an unstaking request message for a coin unstaking request from a participant device, perform a coin unstaking or token minting based on coin unstaking determination information or token minting determination information included in the unstaking request message, generate smart contract data for the coin unstaking or token minting, transmit the smart contract data to at least one blockchain node, verify the smart contract data through cryptographic verification by the blockchain node, add a new block including the smart contract to a distributed ledger, and then provide the participant device with a transaction confirmation indicating that the coin unstaking or token minting is immutably recorded on the blockchain.

5. The server of claim 4, wherein the commands further include, when the unstaking request message includes the token minting determination information, commands implemented to determine a number of mintable tokens, determine a number of tokens to be minted from the number of mintable tokens, and include a determined number of tokens to be minted in the unstaking request message, and
the number of mintable tokens is calculated based on a ratio of a price of withdrawable coin converted into dollar at the time of coin unstaking to a value of a price per token converted into dollar at the time of coin staking.
